(19) United States
(12) Patent Application Publication
(10) Pub. No.: US 2008/0315690 A1
(43) Pub. Date: Dec. 25, 2008

(54) INITIAL CIRCUITS, FULL BRIDGE SWITCHING CIRCUITS AND HALF BRIDGE SWITCHING CIRCUITS

(75) Inventors: Leaf Chen, Taipei (TW); Chih-Shun Lee, Taipei (TW); Chia-Hsin Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEYOND INNOVATION TECHNOLOGY CO., LTD., Taipei (TW)

(21) Appl. No.: 12/040,931

(22) Filed: Mar. 3, 2008

(30) Foreign Application Priority Data
Jun. 23, 2007 (TW) 96122700

(51) Int. Cl. H01H 47/00

(52) U.S. Cl. 307/115

(57) ABSTRACT

An initial circuit is provided. The initial circuit receives a plurality of input signals and controls an initial status of a switching circuit with a plurality of switches. The initial circuit includes a judgment circuit for generating an enable signal according to one of the input signals, and a control circuit for generating a plurality of control signals according to the enable signal and the input signals. The switches are turned off by the control circuit according to the control signals when the switching circuit is in an initial status, and the switches are controlled by the control circuit according to the control signals when the switching circuit is in an operating status.

### BACKGROUND OF THE INVENTION

1. Field of the Invention

The invention relates to an initial circuit, and more particularly to an initial circuit of bridge switching circuits.

2. Description of the Related Art

FIG. 1 shows a diagram of a conventional full bridge switching circuit 100 and a load 150. The full bridge switching circuit 100 comprises four switches 110, 120, 130 and 140. The load 150 may be a fan or a power converter etc. The switches 110 and 130 are P type metal oxide semiconductor (MOS) transistors, and the switches 120 and 140 are N type MOS transistors, wherein four signals S_{A}, S_{B}, S_{C} and S_{D} are used to control the switches 110, 120, 130 and 140, respectively. Furthermore, the switches 110 and 120 are a complementary switch set, and the switches 130 and 140 are another complementary switch set. For this reason, the switches 110 and 120 are not turned on simultaneously, and the switches 130 and 140 are also not turned on simultaneously.

If the full bridge switching circuit 100 is in an operating status, the switches 110 and 140 or the switches 120 and 130 are turned on by the signals S_{A}-S_{D} to provide different power paths to the load 150. In addition, a voltage VDD from a power supply is provided to the full bridge switching circuit 100 when the full bridge switching circuit 100 is in an initial status, and all the signals S_{A}-S_{D} are left at a low logic level due to the de-asserted signals S_{A}-S_{D}. Hence, the switches 110 and 130 are turned on and the switches 120 and 140 are turned off. However, when the PMOS transistors (switches 110 and 130) are turned on, a leakage path exists and causes power consumption of the total system even though the NMOS transistors (switches 120 and 140) are turned off.

Therefore, an initial circuit is desired to turn off all the switches of a bridge switching circuit during an initial status, while not affecting normal operation of each switch during an operating status.

### BRIEF SUMMARY OF THE INVENTION

Initial circuits, full bridge switching circuits and half bridge switching circuits are provided. An exemplary embodiment of such an initial circuit comprises a judgment circuit for generating an enable signal according to one of the input signals, and a control circuit for generating a plurality of control signals according to the enable signal and the input signals. The switches are turned off by the control circuit according to the control signals when the switching circuit is in an initial status, and the switches are controlled by the control circuit according to the control signals when the switching circuit is in an operating status.

Furthermore, an exemplary embodiment of a full bridge switching circuit comprises a first complementary switch set, a second complementary switch set and an initial circuit. The first complementary switch set includes a first switch and a second switch. The second complementary switch set includes a third switch and a fourth switch. The initial circuit generates a first control signal, a second control signal, a third control signal and a fourth control signal to control the first, second, third and fourth switches according to a first input signal, a second input signal, a third input signal and a fourth input signal, respectively. The initial circuit comprises a judgment circuit for generating an enable signal according to at least one of the first, second, third and fourth input signals, and a control circuit for generating the first, second, third and fourth control signals according to the enable signal and the first, second, third and fourth input signals. The first, second, third and fourth switches are turned off when the enable signal is a first logic level, and the first, second, third and fourth switches are controlled by the first, second, third and fourth control signals according to the first, second, third and fourth input signals respectively when the enable signal is a second logic level.

Moreover, an exemplary embodiment of a half bridge switching circuit comprises a first switch, a second switch and an initial circuit. The initial circuit generates a first control signal and a second control signal to control the first and second switches according to a first input signal and a second input signal, respectively. The initial circuit comprises a judgment circuit for generating an enable signal according to at least one of the first and second input signals, and a control circuit for generating the first and second control signals according to the enable signal and the first and second input signals. The first and second switches are turned off when the enable signal is a first logic level, and the first and second switches are controlled by the first and second control signals according to the first and second input signals when the enable signal is a second logic level.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a diagram of a conventional full bridge switching circuit and a load;

FIG. 2 shows an initial circuit according to an embodiment of the invention;

FIG. 3 shows a waveform diagram of the signals shown in FIG. 2;

FIG. 4 shows a half bridge switching circuit according to an embodiment of the invention;

FIG. 5 shows a waveform diagram of the signals shown in FIG. 4; and

FIG. 6 shows an initial circuit according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

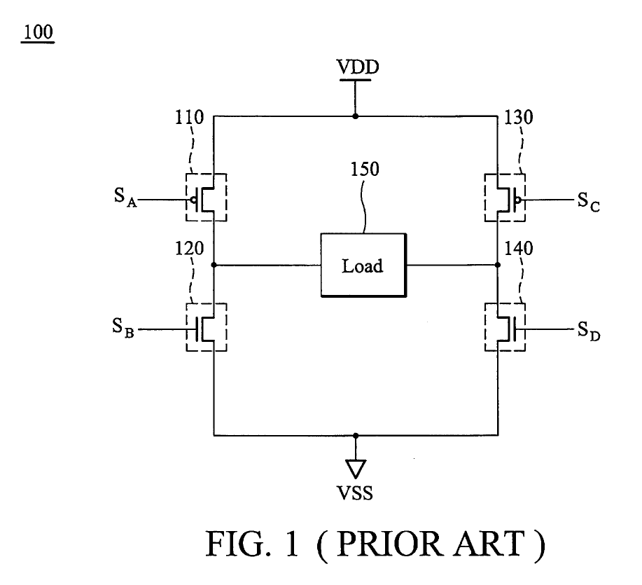

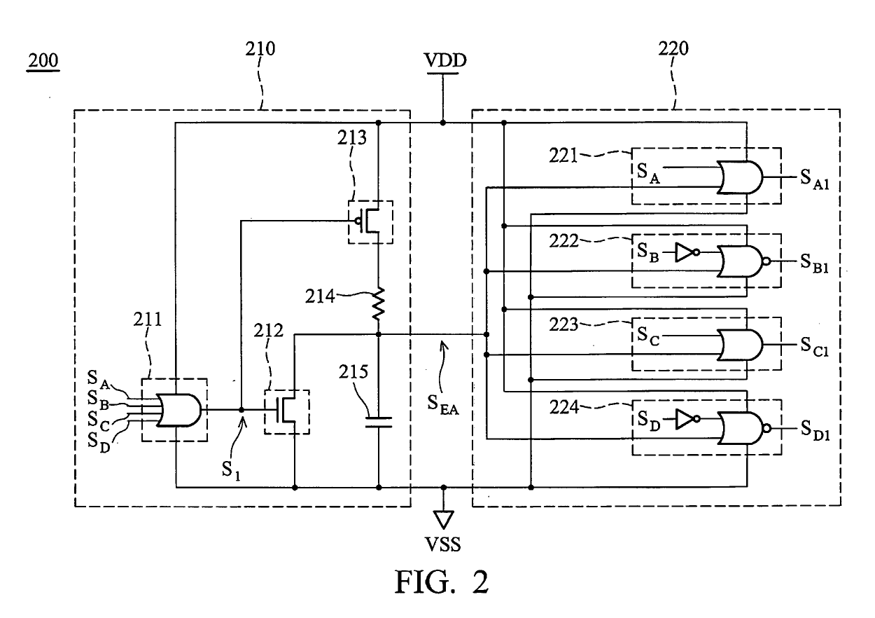

FIG. 2 shows an initial circuit 200 according to an embodiment of the invention. The initial circuit 200 generates new control signal S_{A1}, S_{B1}, S_{C1} and S_{D1} to control the four switches 110-140 according to the original control signal S_{A}-S_{D} of the full bridge switching circuit 100 (shown in FIG.1). The initial circuit 200 comprises a judgment circuit 210 and a control circuit 220. The judgment circuit 210 comprises a logic unit 211, two switches 212 and 213, a resistor 214 and a capacitor 215, wherein the switch 212 is an NMOS transistor and the switch 213 is a PMOS transistor. The control circuit 220 comprises four encode units 221-224, wherein the encode units 221 and 223 have the same logic circuit, and the encode units 222 and 224 have the same logic circuit. Furthermore, for example, the input signals S_{A}-S_{D} may be pulse signals provided from a pulse width modulator. As shown in FIG. 2, the logic unit 211 is an OR gate for generating a signal S₁ according to the input signals S_{A}-S_{D}. The switches 212 and 213 are controlled by the signal S₁ to generate an enable signal S_{EA} through charge/discharge of the capacitor 215. Then, the control circuit 220 can generate the new control signal S_{A1}-S_{D1} according to the enable signal S_{EA} and the input signals S_{A}-S_{D}.

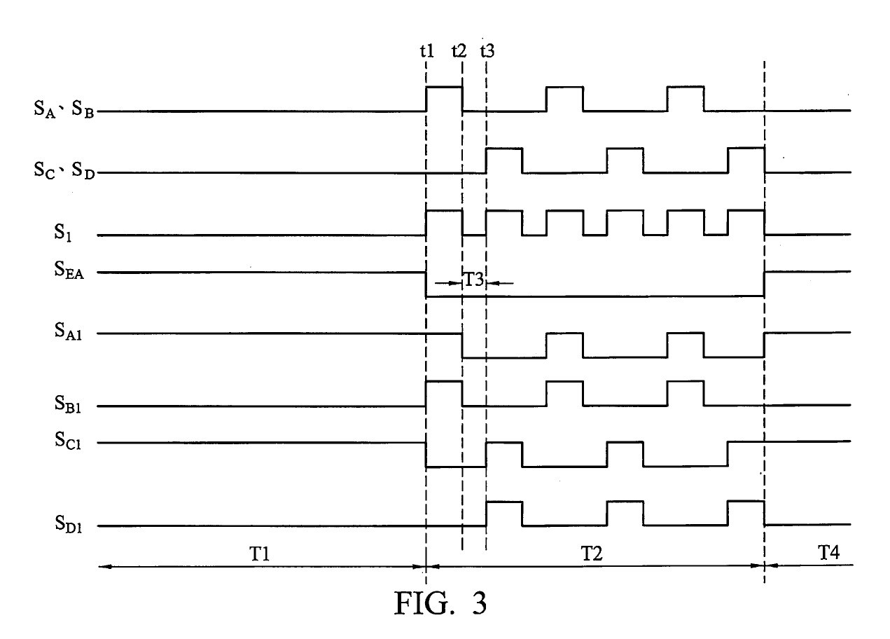

FIG. 3 shows a waveform diagram of the signals shown in FIG. 2. In this embodiment, the signals S_{A} and S_{B} have the same waveform and the signals S_{C} and S_{D} have the same waveform. During an initial status (shown as a period T1), the signals S_{A}-S_{D} are at a low logic level, so the signal S₁ is also at a low logic level. Thus, the switch 213 is turned on and the switch 212 is turned off. Next, the capacitor 215 is charged from a voltage VDD through the switch 213 and the resistor 214, and the enable signal S_{EA} increases voltage gradually to arrive at a high logic level. For the encode units 222 and 224, if the enable signal S_{EA} is at a high logic level, both the signals S_{B1} and S_{D1} are at a low logic level no matter if the signals S_{B} and S_{D} are at a high or low logic levels. For this reason, the switches 120 and 140 shown in FIG. 1 will be turned off. Similarly, for the encode units 221 and 223, if the enable signal S_{EA} is at a high logic level, both the signals S_{A1} and S_{C1} are at a high logic level no matter if the signals S_{A} and S_{C} are at a high or low logic levels. Hence, the switches 110 and 130 shown in FIG. 1 will be turned off. For this reason above, the switches 110-140 (shown in FIG. 1) are turned off and there is no leakage path in the entire system when the full bridge switching circuit 100 is in an initial status.

Furthermore, in time t1, the full bridge switching circuit 100 is operated during an operating status (shown as a period T2). First, the signals S_{A} and S_{B} are changed into a high logic level, while the signals S_{C} and S_{D} are left at a low logic level, so the signal S₁ is changed into a high logic level. Thus, the switch 212 is turned on and the switch 213 is turned off. Next, the capacitor 215 is discharged to a ground VSS through the switch 212, such that the enable signal S_{EA} will decrease voltage to a low logic level. For the encode units 221-224, the signals S_{A1}-S_{D1} are determined by the signals S_{A}-S_{D} when the enable signal S_{EA} is at a low logic level. Therefore, the signals S_{A1}, S_{B1}, S_{C1} and S_{D1} are the same as the signals S_{A}, S_{B}, S_{C} and S_{D}, respectively. Next, in time t2, all the signals S_{A}-S_{D} are at a low logic level, such that the signal S₁ is changed into a low logic level. In time t3, the signals S_{A} and S_{B} are left at a low logic level and the signals S_{C} and S_{D} are changed into a high logic level, so the signal S₁ is changed into a high logic level again. It is to be noted, during an operating status, the signal S₁ may be changed into a low logic level (such as a period T3), and the capacitor 215 is charged from the voltage VDD through the switch 213 and the resistor 214. Therefore, in order to avoid the enable signal S_{EA} from changing into a high logic level during a transient charge time, the values of the resistor 214 and the capacitor 215 are adjusted so that a charge time of the capacitor 215 is greater than a discharge time. Hence, the enable signal S_{EA} will not be changed into a high logic level during the operating status. Finally, when the signals S_{A}-S_{D} are de-asserted (shown as a period T4), the capacitor 215 is continuously charged, thus the enable signal S_{EA} is changed into a high logic level and the switches 110-140 are turned off. In this embodiment, although the signals S_{A} and S_{B} have the same waveforms and the signals S_{C} and S_{D} have the same waveforms, it is to be noted that the invention is not limited thereto. In another embodiment, the signals S_{A} and S_{B} may have different waveforms and the signals S_{C} and S_{D} may have different waveforms.

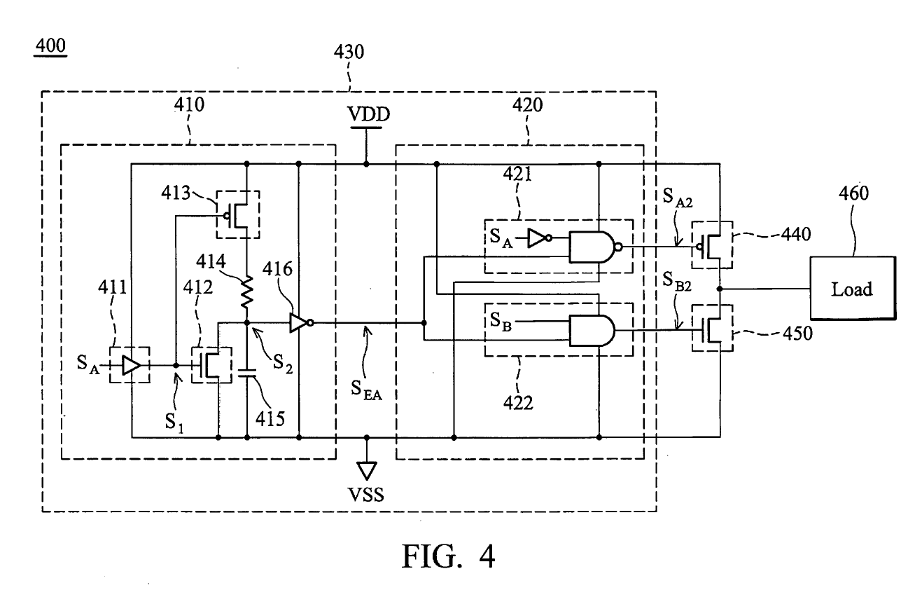

FIG. 4 shows a half bridge switching circuit 400 according to an embodiment of the invention. The half bridge switching circuit 400 comprises an initial circuit 430, two switches 440 and 450 and a load 460, wherein the initial circuit 430 comprises a judgment circuit 410 and a control circuit 420. The judgment circuit 410 comprises a logic unit 411, two switches 412 and 413, a resistor 414, a capacitor 415 and an inverter 416. In this embodiment, the logic unit 411 is a buffer for generating a signal S₁ according to a signal S_{A}. Furthermore, an enable signal S_{EA} is generated by a signal S₂ through the inverter 416, wherein the signal S₂ is stored in the capacitor 415. Therefore, during an initial status, the enable signal S_{EA} is at a low logic level, so a signal S_{A2} is at a high logic level and a signal S_{B2} is at a low logic level such that the switches 440 and 450 are turned off. During the operating status, the enable signal S_{EA} is changed into a high logic level, so the signals S_{A2} and S_{B2} are determined by the signals S_{A} and S_{B}.

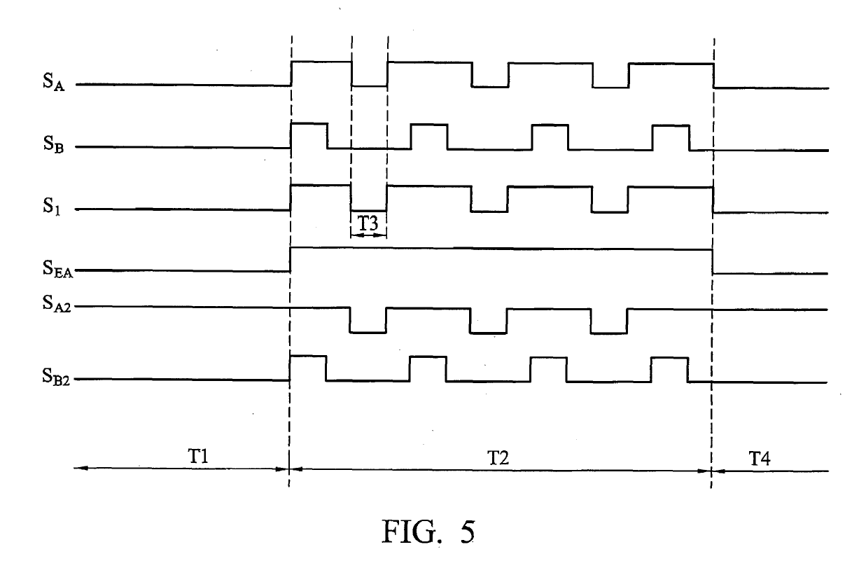

FIG. 5 shows a waveform diagram of the signals shown in FIG. 4. In this embodiment, the signal S₁ is generated by one of the input control signals (ex. the signal S_{A}). Therefore, the signal S₁ may be generated according to any control signals or combination thereof. Moreover, the logic unit 411 may be omitted and the signal S_{A} is directly coupled to the switches 412 and 413. In one embodiment, the logic unit 411 may comprise other logic circuits corresponding to the logic level of the enable signal S_{EA} during an initial and operating status. In another embodiment, the inverter 416 may comprise a Schmitt trigger circuit to avoid a damping phenomenon of the enable signal S_{EA} caused by charge/discharge of the capacitor 415.

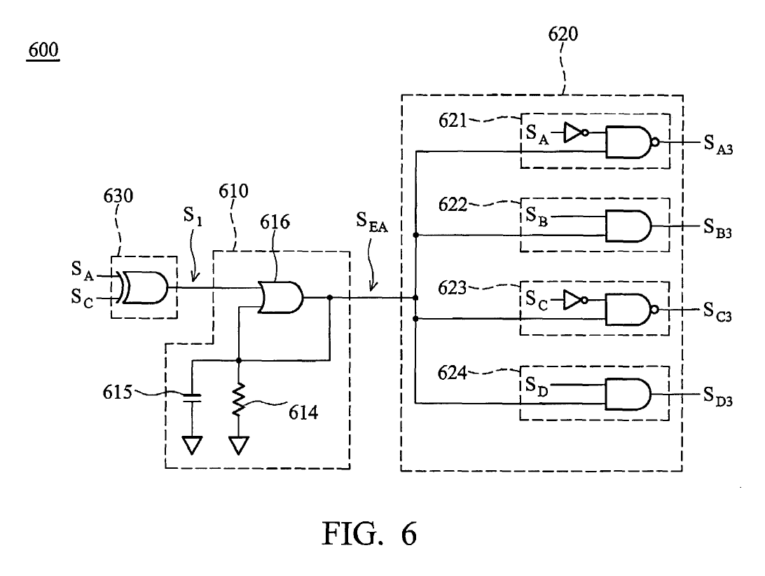

FIG. 6 shows an initial circuit 600 according to another embodiment of the invention, wherein the initial circuit 600 is used for controlling the switches 110-140 shown in FIG. 1. The initial circuit 600 comprises a judgment circuit 610, a control circuit 620 and a logic circuit 630. The judgment circuit 610 comprises an OR gate 616, a resistor 614 and a capacitor 615. The logic circuit 630 is an XOR gate for generating a signal S₁ according to the signals S_{A} and S_{C}. In this embodiment, the signals S_{A} and S_{C} are left at a low logic level during an initial status, so the signals S₁ and S_{EA} are also left at a low logic level. Therefore, the signals S_{A3} and S_{C3} are at a high logic level and the signals S_{B3} and S_{D3} are at a low logic level, such that the switches 110-140 shown in FIG. 1 are turned off. Furthermore, in this embodiment, the judgment circuit 610 uses the OR gate 616 to control a charge/discharge of the capacitor 615. In another embodiment, the logic circuit 630 is an OR gate and the capacitor 615 is a parasitic capacitor of the OR gate 616. In addition, the logic circuit 630 may be contained inside the judgment circuit 610.

As described above, the initial circuit of the invention is applied to various bridge switching circuits, such as full or half bridge switching circuits. The judgment circuit and control circuits of the initial circuit may comprise various design circuits in accordance with the bridge switching circuit type and application requirements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An initial circuit for receiving a plurality of input signals and controlling an initial status of a switching circuit with a plurality of switches, comprising:
a judgment circuit for generating an enable signal according to one of the input signals; and
a control circuit for generating a plurality of control signals according to the enable signal and the input signals,
wherein the switches are turned off by the control circuit according to the control signals when the switching circuit is in an initial status, and the switches are controlled by the control circuit according to the control signals when the switching circuit is in an operating status.

2. The initial circuit as claimed in claim 1, wherein the judgment circuit comprises:
a first logic unit for generating a first signal according to the input signals;
a first switch coupled between a power supply voltage and a first resistor, having a first control terminal for receiving the first signal;
a first capacitor coupled between the first resistor and a ground for generating the enable signal; and
a second switch coupled between the first resistor and the ground, having a second control terminal for receiving the first signal.

3. The initial circuit as claimed in claim 2, wherein the first logic unit is an OR gate.

4. The initial circuit as claimed in claim 1, wherein the judgment circuit comprises:
a second logic unit for generating a second signal according to the input signals;
an OR gate having a first input terminal for receiving the second signal, a second input terminal and an output terminal coupled to the second input terminal for generating the enable signal;
a second capacitor coupled between the second input terminal and a ground; and
a second resistor coupled between the second input terminal and the ground.

5. The initial circuit as claimed in claim 4, wherein the second logic unit is one of an OR gate and an XOR gate.

6. The initial circuit as claimed in claim 1, wherein the input signals comprises a first input signal and a second input signal, and the switches comprises a first switch and a second switch, wherein the first switch is turned off when the second switch is turned on and the second switch is turned off when the first switch is turned on.

7. The initial circuit as claimed in claim 6, wherein the control circuit comprises a first encode unit and a second encode unit coupled to the first switch and the second switch, respectively.

8. The initial circuit as claimed in claim 7, wherein the first switch and the second switch are separately turned off by the first encode unit and the second encode unit according to the enable signal when the switching circuit is in an initial status.

9. The initial circuit as claimed in claim 7, wherein the first switch is controlled by the first encode unit according to the first input signal and the second switch is controlled by the second encode unit according to the second input signal when the switching circuit is in an operating status.

10. The initial circuit as claimed in claim 1, wherein the enable signal is a high logic level signal when the switching circuit is in an initial status.

11. A full bridge switching circuit, comprising:
a first complementary switch set having a first switch and a second switch;
a second complementary switch set having a third switch and a fourth switch; and
an initial circuit for generating a first control signal, a second control signal, a third control signal and a fourth control signal to control the first, second, third and fourth switches according to a first input signal, a second input signal, a third input signal and a fourth input signal respectively, comprising:
a judgment circuit for generating an enable signal according to at least one of the first, second, third and fourth input signals; and
a control circuit for generating the first, second, third and fourth control signals according to the enable signal and the first, second, third and fourth input signals,
wherein the first, second, third and fourth switches are turned off when the enable signal is a first logic level, and the first, second, third and fourth switches are controlled by the first, second, third and fourth control signals according to the first, second, third and fourth input signals respectively when the enable signal is a second logic level.

12. The full bridge switching circuit as claimed in claim 11, wherein the first switch is turned off when the second switch is turned on and the second switch is turned off when the first switch is turned on, and the third switch is turned off when the fourth switch is turned on and the third switch is turned off when the fourth switch is turned on.

13. The full bridge switching circuit as claimed in claim 11, wherein the judgment circuit comprises:
a first logic unit for generating a first signal according to at least one of the first, second, third and fourth input signals;
a fifth switch coupled between a power supply voltage and a first resistor, having a first control terminal for receiving the first signal;
a first capacitor coupled between the first resistor and a ground for generating the enable signal; and
a sixth switch coupled between the first resistor and the ground, having a second control terminal for receiving the first signal.

14. The full bridge switching circuit as claimed in claim 11, wherein the judgment circuit comprises:
a second logic unit for generating a second signal according to at least one of the first, second, third and fourth input signals;
an OR gate having a first input terminal for receiving the second signal, a second input terminal and an output terminal coupled to the second input terminal for generating the enable signal;
a second capacitor coupled between the second input terminal and a ground; and
a second resistor coupled between the second input terminal and the ground.

15. The full bridge switching circuit as claimed in claim 14, wherein the second logic unit is one of an OR gate and an XOR gate.

16. The full bridge switching circuit as claimed in claim 11, wherein the control circuit comprises
a first encode unit coupled to the first switch for generating the first control signal according to the enable signal and the first input signal;
a second encode unit coupled to the second switch for generating the second control signal according to the enable signal and the second input signal;
a third encode unit coupled to the third switch for generating the third control signal according to the enable signal and the third input signal; and
a fourth encode unit coupled to the fourth switch for generating the fourth control signal according to the enable signal and the fourth input signal.

17. The full bridge switching circuit as claimed in claim 11, further comprising a pulse width modulator for providing the first, second, third and fourth input signals.

18. A half bridge switching circuit, comprising:
a first switch;
a second switch; and
an initial circuit for generating a first control signal and a second control signal to control the first and second switches according to a first input signal and a second input signal respectively, comprising:
a judgment circuit for generating an enable signal according to at least one of the first and second input signals; and
a control circuit for generating the first and second control signals according to the enable signal and the first and second input signals,
wherein the first and second switches are turned off when the enable signal is a first logic level, and the first and second switches are controlled by the first and second control signals according to the first and second input signals when the enable signal is a second logic level.

19. The half bridge switching circuit as claimed in claim 18, wherein the first switch is turned off when the second switch is turned on, and the second switch is turned off when the first switch is turned on.

20. The full bridge switching circuit as claimed in claim 18, wherein the judgment circuit comprises:
a first logic unit for generating a first signal according to at least one of the first and second input signals;
a third switch coupled between a power supply voltage and a first resistor, having a first control terminal for receiving the first signal;
a first capacitor coupled between the first resistor and a ground for generating the enable signal; and
a fourth switch coupled between the first resistor and the ground, having a second control terminal for receiving the first signal.

21. The half bridge switching circuit as claimed in claim 18, wherein the judgment circuit comprises:
a second logic unit for generating a second signal according to at least one of the first and second input signals;
an OR gate having a first input terminal for receiving the second signal, a second input terminal and an output terminal coupled to the second input terminal for generating the enable signal;
a second capacitor coupled between the second input terminal and a ground; and
a second resistor coupled between the second input terminal and the ground.

22. The half bridge switching circuit as claimed in claim 18, wherein the control circuit comprises
a first encode unit coupled to the first switch for generating the first control signal according to the enable signal and the first input signal; and
a second encode unit coupled to the second switch for generating the second control signal according to the enable signal and the second input signal.
